(19) United States
(12) Patent Application Publication
(10) Pub. No.: US 2023/0150225 A1
(43) Pub. Date: May 18, 2023

(54) AUTOMOTIVE LAMINATE WITH ENHANCED SENSOR WINDOW AND ADDITIONAL FUNCTIONALITY

(71) Applicant: AGP America S.A., Ciudad de Panama (PA)

(72) Inventors: Mario Arturo MANNHEIM ASTETE, Lima (PE); Juan Pablo SUÁREZ, Aachen (DE); Christian KREBS, Cologne (DE); Frank A. HUAMAN, Lima (PE); Pooria HOSSEINI, Herzongerath (DE); Amey KENJALE, Baesweiler (DE)

(21) Appl. No.: 18/050,965

(22) Filed: Oct. 28, 2022

Related U.S. Application Data
(63) Continuation of application No. PCT/IB2021/053555, filed on Apr. 28, 2021.
(60) Provisional application No. 63/016,825, filed on Apr. 28, 2020.
(60) Provisional application No. 63/016,825, filed on Apr. 28, 2020.

(51) Int. Cl. B32B 3/26; B32B 7/12; B32B 17/10; B32B 27/08; B32B 3/08

(52) U.S. Cl. CPC B32B 3/266; B32B 3/08; B32B 7/12; B32B 17/10036; B32B 27/08; B32B 27/30

(57) ABSTRACT

The use of camera based automotive safety systems is growing at a rapid rate. As the industry moves towards full autonomous capability, the resolution and number of cameras required is increasing. At the same time windshields, behind which many of the cameras are mounted, are becoming larger and more complex. Achieving acceptable optical quality can be challenging due to continually evolving optical requirements generated by the rapid development of camera systems and processing algorithms as well as variations in the index of refraction, curvature, bend, thickness, and other variables. The laminate of the disclosure has a portion of the inner glass layer removed in the camera field of view and replaced with a high optical quality insert bonded to the glass. This allows for much greater optical quality, while retaining durability and functionality of a standard laminate.

### CROSS-REFERENCE TO RELATED APPLICATIONS

This application is a continuation in part of Patent Cooperation Treaty application number PCT/IB2021/053555 filed on Apr. 28, 2021, and claims priority from U.S. Provisional Application Serial No. 63/016,825 filed on Apr. 28, 2020, both of which are incorporated by reference herein on their entirety.

### FIELD OF THE DISCLOSURE

This disclosure relates to the field of laminated automotive glazing.

### BACKGROUND OF THE DISCLOSURE

The use of camera-based safety systems, requiring a wide field of view and a high level of optical clarity, is growing at a rapid rate. As the industry moves towards full autonomous capability, the number of cameras and resolution is increasing. At the same time windshields, behind which many of the cameras are mounted, are becoming larger and more complex in shape.

The main cameras require a high, forward looking field of view and so must typically be mounted high on the windshield and in the wiper area. Camera based systems are used to provide a wide array of safety functions including adaptive cruise control, obstacle detection, lane departure warning and support for autonomous operation. Many of these applications require the use of multiple cameras. A clear undistorted field of view, with high light transmission, little or no color shift, minimal double imaging and excellent MTF (Modulation Transfer Function, a measure of how well a lens maps an image to a sensor), is especially critical for camera-based systems to perform as intended. It is essential for these systems to be able to quickly differentiate between objects, capture text, identify signage, and operate under low lighting conditions. Further, as the resolution of the cameras used and the corresponding optical requirements generated by the continually evolving and rapid development of cameras, electronics and processing algorithms increase, these needs increase. Automotive glazing, with optical quality more than sufficient for human vision, may well fall short of what is needed for machine vision.

Laminated windshields are made by bonding two sheets of annealed glass together using a thin sheet of a transparent thermoplastic interlayer as shown in FIG. 1. Annealed glass is glass that has been slowly cooled from the bending temperature down through the glass transition range. This process relieves most of the stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. On impact, the plastic layer also helps to prevent penetration by the occupant in the event of a crash and by objects striking the laminate from the exterior. This characteristic of laminated glass becomes even more important with the presence of expensive, safety critical, electronic components mounted to or in close proximity to the glass. The electronic components must be protected from impact, as well as water ingress, by the windshield. While a vehicle with a broken windshield may still be operated, any breakage in the camera field of view is likely to disable the camera system.

This laminated construction presents problems in the area of optics. For one, the camera is looking out through at least two layers of bent glass bonded together by a third layer of plastic. Secondary reflections from the multiple surfaces can result in double image. The curvature of the glass, in conjunction with the often-low installation angle, can also contribute to double image as well as further reducing the optical quality of the field of view.

There are several other variables that affect optical quality which include but are not limited to: draw line distortion, variation in bend from windshield to windshield, mismatch between the bent shape of the two glass layers, variation in the thickness of the layers, variation in the optical quality of the layers, variation in the glass composition and variation in the index of refraction.

Even when all variables are controlled and held consistent and are at or very near the desired values, the optical quality of the laminate may not be sufficient for the camera system.

The types of glass that are optimal for automotive applications and human vision are often not suitable for camera use. An infra-red reflecting film or coating is a common means used to reduce the solar load on the vehicle. As the film or coating is located between the inner and outer glass layers of the laminate, the outer glass layer is typically made using a clear or ultra-clear glass composition, having a high level of light transmission, so as to not absorb the solar energy initially transmitted through the glass layer and then reflected back a second time through the glass. Clear and ultra-clear glass is optimal for cameras. However, the inner glass layer is typically comprised of a solar control heat absorbing glass when used with an infra-red reflecting film or coating. The glass tint, typically green, absorbs at least some of the energy that the film or coating does not reflect. Solar control glass is also often used for the outer glass layer on laminates that do not have a solar control coating or film. This is sometimes done for bending optimization as well as for solar control. This type of solar control glass will have a lower level of visible light transmission and will also tend to shift the color both of which are also undesirable for the camera.

In the same manner, infra-red reflecting films and coatings also can reduce light transmission and cause a color shift. It is standard practice to remove the infra-red reflecting film or coating in the camera area. However, the plastic interlayer which must be present to bond the opposite glass layers, especially some of the performance interlayers which have various additives and/or layers, can also degrade optical quality by increasing haze, reducing light transmission, and causing a color shift due to their composition. The interlayers may also contribute to optical distortion due to variations in thickness and the typical embossing of the surface that is done to air evacuation during the lamination process.

The regulatory requirement for visible light transmission through a windshield is that it must be greater than 70%. To reduce solar load, windshields are usually manufactured to have the visible light transmission as close to this limit as practical. The ideal for visible light transmission in the camera area is 100% so that the camera receives as much light as it would if there were not looking out from behind the windshield.

Thus, a windshield that is considered to have excellent optical quality for human vision and meet all regulatory requirements, may fall short of what is required by a safety critical high-resolution camera system.

One approach that has been used to address this concern has been to cutout a portion of the inner layer of glass, eliminating the inner glass layer and the plastic interlayer in the camera field of view. A cross section illustrating this approach is shown in FIG. 5A. The practice of cutting a notch in the inner layer to provide access to make an electrical connection to an antenna, defroster, or other circuit, has been known and in use for many decades. The same typical score and snap means used to cut the peripheral shape of the glass may be employed to cut the notch. A secondary means may be required depending upon the complexity of the notch shape. Such means are well known and understood in the industry and include but are not limited to grinding and LASER cutting. The notch is generally placed in the area of the laminate hidden by the black obscuration applied to the outer glass layer. When the depth of the notch is substantially greater than the glass thickness it is typical to fill the notch with a plastic or other type of material so as to strengthen the laminate and reduce the risk of breakage.

This approach, when used with windshields for use with camera systems, does improve the optical quality by eliminating some of the variation and variables associated with the inner glass and plastic interlayer layers as well as by reducing the number of layers in the optical path but has serious drawbacks. For one, the single thin outer glass layer is far weaker and much more likely to break, in the event of impact or other mechanical stress, than a comparable full laminate. In the event of breakage, the cutout area is left unprotected from penetration and water ingress due to the lack of the second glass layer bonded to the outer glass layer. Spall from the broken glass may also be expelled inside the passenger compartment compromising the integrity of the cameras and other sensors located there. This configuration also will not meet regulatory requirements for safety due to the compromised penetration resistance in the camera area.

It would be desirable to overcome these limitations providing a laminated glazing with superior optical quality and performance.

### BRIEF SUMMARY OF THE DISCLOSURE

The disclosure provides for a laminated glazing with a cutout area in the inner layer of glass providing an optically superior and improved field of view for one or more cameras. The inner glass layer removed is replaced by an insert, having higher optical quality than the glass, which is bonded to the outer glass layer by means of an optical adhesive.

The insert increases the strength and resistance to breakage of the cutout area. The insert and bonding means serve the same function that the second glass layer and interlayer does in a laminate. In the event of breakage, the insert and bonding means will hold the broken edges together and will serve to prevent penetration and exposure to the elements and exterior.

The insert may be comprised of a single layer. Alternately, two or more layers may be used to form a multi-layer insert. Layers comprising the multi-layer insert may have different sizes (e.g. length) and/or thicknesses and may be bonded by optical adhesive means.

The insert may be provided with a transparent conductive coating 30 allowing for electrical heating of the insert and associated field of view. One such example of a heated insert is shown in FIG. 2. The insert may be provided with a variety of coating including but not limited to anti-glare, anti-reflective, anti-fog, and others.

The edge of the insert may be extended such as to overlap the edge of the cutout such that the insert is captured by and bonded to both the inner and outer glass layers to further improve the strength and penetration resistance of the laminate. Various embodiments are illustrated in FIGS. 4A, 4B, 4C, 5C, 5D, 6B, 6C, 9A, 9B, 9C and 10A (not to scale).

The insert may also be size to essentially the same or slightly small than the cutout as shown in 5B, 6A, 10B and 10C.

The insert may be equipped with a lens, as show in FIG. 5D, or manufactured such as to serve as a lens to correct for any optical aberrations present.

An obscuration may be printed on the insert, on the interlayer, on a film, or on a separate opaque layer bonded to the insert. A printed non-plasticized PVB film may be used as an obscuration. The obscuration 6 may be printed on the insert as illustrated in FIGS. 6C and 9B. The obscuration may be a separate layer laminated to the insert as shown in FIGS. 6A, 6B and 6D. The obscuration 6 may be comprised of an opaque material of which include but are not limited to a black non-plasticized PVB and black PET. Eliminating the black enamel frit (enamel frit embodiments as shown in FIGS. 4A, 4B, 4C, 5A, 5B, 5C, 5D, 8, 9A and 10A) has been shown to further improve the optical quality of the glass. The obscuration may be implemented as an integral part of the insert by bonding the clear portion of the insert to an opaque material of substantially the same thickness.

A plurality of lens, each with a different optical profile, may be provided with the windshield measured after lamination and fitted with the lens having the best correction.

A mounting bracket may be attached to the insert (FIG. 4C), the inner glass (FIG. 4A) or to both the insert and the inner glass (FIG. 4B).

Advantages:
Superior optical quality.
Elimination of the printed and fired enamel frit obscuration.
Corrects for curvature of glass.
Eliminates double image.
Compensates for installation angle.
Improved safety.
Improved penetration resistance.
Improved breakage resistance.
Complies with regulatory requirements.
No added reinforcement needed at edge of insert.
Fabricated using standard automotive glass processes.

### BRIEF DESCRIPTION OF THE SEVERAL VIEWS OF THE DRAWINGS

These features and advantages of the present disclosure will become apparent from the detailed description of the following embodiments in conjunction with the accompanying drawings. Note that the Figures are not drawn to scale as the thickness of some of the features (obscuration, coatings, film) would not be readily visible otherwise in cross sections.

FIG. 1A shows a cross section: typical laminated automotive glazing.

FIG. 1B shows a cross section: typical laminated automotive glazing with performance film and coating.

FIG. 1C shows a cross section: typical tempered monolithic automotive glazing.

FIG. 2 shows an exploded view: windshield with camera cutout and insert.

FIG. 3 shows an isometric view: panoramic windshield with camera cutout and insert.

FIG. 4A shows a cross section: camera cutout with insert. Mounting bracket bonded to inner glass layer.

FIG. 4B shows a cross section: camera cutout with insert. Mounting bracket bonded to inner glass layer and insert.

FIG. 4C shows a cross section: camera cutout with insert. Mounting bracket bonded to insert.

FIG. 5A shows a cross section: camera cutout in inner glass layer with no insert.

FIG. 5B shows a cross section: camera cutout in inner glass layer with an insert smaller than or equal to cutout and filler in gap between insert and cutout.

FIG. 5C shows a cross section: camera cutout in inner glass layer with an insert larger than cutout.

FIG. 5D shows a cross section: camera cutout in inner glass layer with an insert larger than cutout and lens bonded to insert.

FIG. 6A shows a cross section: camera cutout in inner glass layer with an insert smaller than or equal to cutout. Filler in gap between insert and cutout. Obscuration bonded to insert.

FIG. 6B shows a cross section: camera cutout in inner glass layer with an insert larger than cutout bonded to inner glass. Obscuration bonded to insert.

FIG. 6C shows a cross section: camera cutout in inner glass layer and lens bonded to insert. Obscuration printed on insert.

FIG. 6D shows a cross section: camera cutout in inner glass layer with a thin printed black PVB obscuration layer and an insert bonded to the PVB and obscuration layer with a pressure sensitive adhesive

FIG. 7 shows an insert with heating means and switchable layer.

FIG. 8 shows an exploded view: panoramic windshield with camera cutout and insert.

FIG. 9A shows a cross section: Insert with PVB used as adhesive and optical adhesive to secure insert to glass plies and obscuration applied to surface two.

FIG. 9B shows a cross section: Insert with PVB used as adhesive and optical adhesive to secure insert to glass plies and obscuration applied to insert.

FIG. 9C shows a cross section: Insert with PVB used as adhesive and optical adhesive to secure insert to glass plies and obscuration formed as a part of the insert.

FIG. 10A shows a cross section with insert bonded to surface three of the inner glass layer.

FIG. 10B shows a cross section with insert bonded to surface three, the edge of the cut and surface four of the inner glass layer.

FIG. 10C shows a cross section with insert bonded to surface three, the edge of the cut and surface four of the inner glass layer and a reinforcement.

FIG. 11 shows a cross section with multi-layer insert comprising an obscuration layer, a conductive coated defroster layer and an anti-reflective coated layer. Switchable film sandwiched between two interlayers, adhesive bonding insert to inner glass layer and a reinforcement overlapping the insert a surface four of the inner glass.

FIG. 12 shows a cross section with an insert comprising a functional layer. The functional layer is bonded to the outer glass layer by an optical adhesive comprised of a pressure sensitive adhesive and a black obscuration printed on a thin film.

FIG. 13 shows a cross section with a multi-layer insert comprising a chemically tempered aluminosilicate glass and a functional layer. The multi-layer insert is bonded to the outer glass layer by an optical adhesive comprised of a pressure sensitive adhesive and a black obscuration printed on a thin film.

### REFERENCE NUMERALS

2 Glass
4 Bonding/Adhesive layer/Plastic Interlayer
6 Obscuration/Black Paint
8 Mounting bracket
9 Insert
12 Infrared reflecting film
14 Lens
16 Camera
18 Coating
20 Pressing plate
22 Cut out
24 Filler
26 Adhesive
28 Optical adhesive
30 Transparent conductive coating
32 Bus bar
34 Switchable layer
36 Heating means
38 Reinforcement
40 Anti-reflective coated layer
42 Conductive coated defroster layer
44 Obscuration layer
45 Functional layer
46 Penetration resistance layer
91 Pressure sensitive optical adhesive
101 Exterior side of glass layer 1 (201), number one surface.
102 Interior side of glass layer 1 (201), number two surface.
103 Exterior side of glass layer 2 (202), number 3 surface.
104 Interior side of glass layer 2 (202), number 4 surface.
201 Outer glass layer
202 Inner glass layer

### DETAILED DESCRIPTION OF THE DISCLOSURE

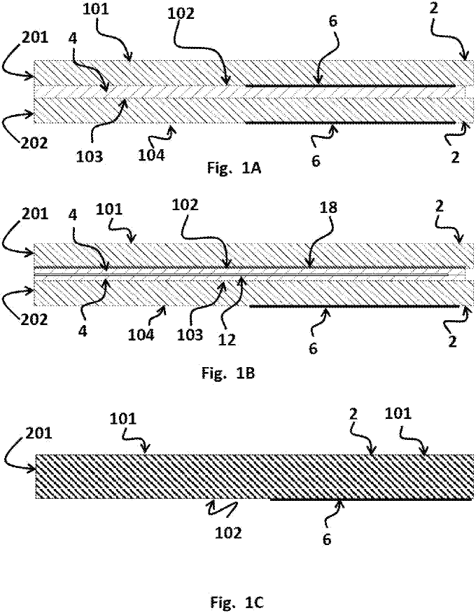

The following terminology is used to describe the laminated glazing of the disclosure. Typical automotive laminated glazing cross sections are illustrated in FIGS. 1A and 1B. A laminate is comprised of two layers of glass, the exterior or outer 201 and interior or inner 202 that are permanently bonded together by a plastic layer 4 (interlayer). In a laminate, the glass surface that is on the exterior of the vehicle is referred to as surface one 101 or the number one surface. The opposite face of the outer glass layer 201 is surface two 102 or the number two surface. The glass surface that is on the interior of the vehicle is referred to as surface four 104 or the number four surface. The opposite face of the inner layer of glass 202 is surface three 103 or the number three surface. Surfaces two 102 and three 103 are bonded together by the plastic layer 4. An obscuration 6 may be also applied to the glass. Obscurations are commonly comprised of black enamel frit printed on either the number two 102 or number four surface 104 or on both. The laminate may have a coating 18 on one or more of the surfaces. The laminate may also comprise a film 12 laminated between at least two plastic layers 4.

FIG. 1C shows a typical tempered automotive glazing cross section. Tempered glazing is typically comprised of a single layer of glass 201 which has been heat strengthened. The glass surface that is on the exterior of the vehicle is referred to as surface one 101 or the number one surface. The opposite face of the outer glass layer 201 is surface two 102 or the number two surface. The number two surface 102 of a tempered glazing is on the interior of the vehicle. An obscuration 6 may be also applied to the glass. Obscurations are commonly comprised of black enamel frit printed on the number two 102 surface. The glazing may have a coating 18 on the number one 101 and /or number two 102 surfaces.

The term “glass” can be applied to many inorganic materials, include many that are not transparent. For this document we will only be referring to nonorganic transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid. If during the cooling of this fluid below the fusion temperature the viscosity is too high or the cooling rate too fast, the crystallization does not have time to occur. The material is then in an unstable state since it is liquid below its melting point, it is then called a supercooled liquid. In continuing the cooling, the viscosity of the liquid will increase very quickly until the material can be qualified as a solid, a glass.

The types of glass 2 that may be used include but are not limited to: the common soda-lime variety typical of automotive glazing as well as aluminosilicate, lithium aluminosilicate, borosilicate, transparent glass ceramics, and the various other inorganic solid amorphous compositions which undergo a glass transition and are classified as glass included those that are not transparent. The glass layers may be comprised of heat absorbing glass compositions and may be treated with infrared reflecting and other types of coatings 18. Transparent ceramics, which are not technically glass, may also be used.

The plastic bonding layer 4 (interlayer) has the primary function of bonding the major faces of adjacent layers to each other. The material selected is typically a clear thermoset plastic.

For automotive use, the most commonly used bonding layer 4 (interlayer) is polyvinyl butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over the temperature range required for an automobile. Only a small number of plasticizers are used. They are typically linear dicarboxylic esters. Two in common use are di-n-hexyl adipate and tetra-ethylene glycol di-n-heptanoate. A typical automotive PVB interlayer is comprised of 30-40% plasticizer by weight.

In addition to polyvinyl butyl, ionoplast polymers, ethylene vinyl acetate (EVA), cast in place (CIP) liquid resin and thermoplastic polyurethane (TPU) can also be used. Automotive interlayers are made by an extrusion process with has a thickness tolerance and process variation. As a smooth surface tends to stick to the glass, making it difficult to position on the glass and also to trap air, to facilitate the handling of the plastic sheet and the removal or air (deairing) from the laminate, the surface of the plastic is normally embossed contributing additional variation to the sheet. Standard thicknesses for automotive PVB interlayer at 0.38 mm and 0.76 mm (15 and 30 mil).

Interlayers are available with functions in addition to bonding the glass layers together. These include that can be used to increase the strength of glass. They are thermal strengthening, in which the hot glass is rapidly cooled (quenched) placing the outer layer of glass in compression and chemical tempering which achieves the same effect through an ion exchange chemical treatment. In the chemical tempering process, ions in and near the outside surface of the glass are exchanged with ions that are larger. Compressive strengths of up to 1,000 MPa are possible with chemical tempering.

The use of thin glass layers has been found to improve resistance to breakage from impact such as from stone chips. The thinner glass is more flexible and absorbs the energy of the impact by deflecting and then bouncing back rather than breaking as is the case with a thicker stiffer layer of glass. Also, embodiments comprising a borosilicate outer layer are substantially more resistant to impact than soda lime glass due to the nature of the composition. Embodiments comprising a chemically tempered layer will also exhibit superior resistance to impact as compared to ordinary soda-lime glass due to the high surface compression of such glasses.

Thin chemically tempered glass can be bent cold. Cold bending is a relatively new technology. As the name suggest, the glass is bent, while cold to its final shape, without the use of heat. On parts with minimal curvature a flat sheet of glass can be bent cold to the contour of the part. This is possible because as the thickness of glass decreases, the sheets become increasingly more flexible and can be bent without inducing stress levels high enough to significantly increase the long-term probability of breakage. Thin sheets of annealed soda-lime glass, in thicknesses of about 1 mm, can be bent to large radii cylindrical shapes (greater than 6 m). When the glass is chemically, or heat strengthened the glass can endure much higher levels of stress and can be bent along both major axes. The process is primarily used to bend chemically tempered thin glass sheets (<=1 mm) to shape.

A number of technologies are available that can be used to control the level of light transmission through the laminate. They include but are not limited to electrochromic, photochromic, thermochromic and electric field sensitive films which are designed to be incorporated into laminated glass. Of particular interest are suspended particle device (SPD) films, liquid crystal (LC) and polymer dispensed liquid crystal (PDLC) films which can quickly change their light transmittance in response to an electrical field. Laminates that incorporate these variable light transmittance technologies are sometime referred to as “smart” glass or switchable.

A switchable film layer can be used, with the insert of the disclosure, to control the level of light and also to hide the camera when not in use.

The camera field of view needs to be kept clear of fog, ice, and snow. As the electronics mounted to the interior surface of the glass will block any flow of hot air, resistive heating elements are typically used. The insert of the disclosure may further comprise electrically resistive heating elements including but not limited to transparent conductive coating, wires embedded in a plastic layer, printed conductive ink, silver frit and other conductive materials deposited by a variety of other means.

As can be appreciated, while the disclosure is of prime benefit and a solution to the problems of camera systems, the disclosure is also of benefit to a range of other sensors including but not limited to rain sensors, high beam detectors, LIDAR, near infra-red and long wave infra-red thermal cameras. For this disclosure we shall define camera to include the range of other cameras and sensors that may also benefit by the disclosure. The disclosure is comprised of a laminate having two glass layers with each having opposed major faces bonded together permanently by at least one plastic bonding layer and having at least one cutout in the inner glass layer in the area in the camera field of view of at least one camera. The camera location may be in the top center area of the windshield, the typical location on standard windshields. In this case, the cutout may extend to the edge of glass. This has the advantage in that the glass may possibly be cut using the standard and common place score and snap method of cutting.

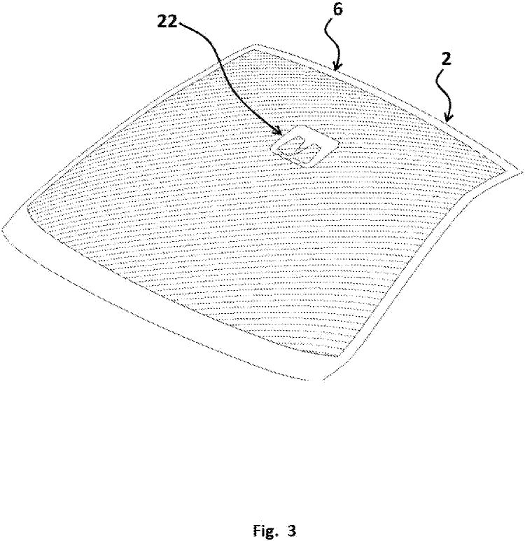

Other locations on the windshield may be used. If the location of the cutout is inboard from the edge of glass, such as on a panoramic windshield (FIGS. 3 & 8), a hole rather than a notch may be needed. In this case, the hole may be cut by means of a waterjet, LASER, grinder, or other appropriate means.

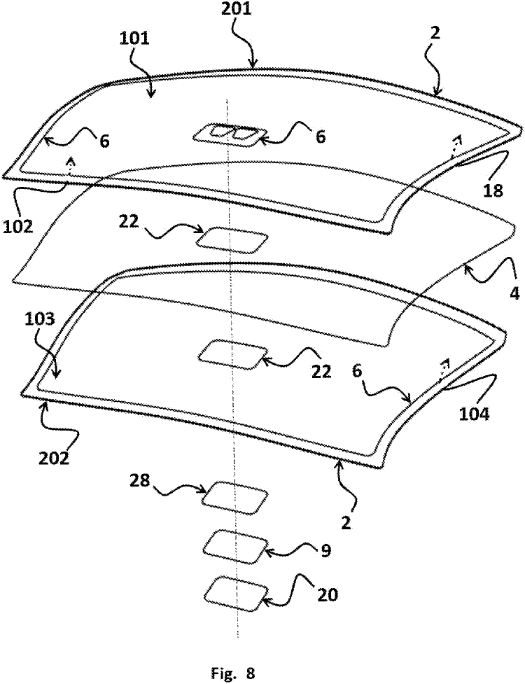

This cutout area can present bending problems due to non-uniform heating and thickness in this area. To solve this problem, a glass plate is made which is of the same size as the cutout and of the same composition and thickness as the inner glass layer. This plate is then inserted into the cutout and left there during bending. By doing so, the glass bends the same as it would without the cutout. The plate is discarded as it does not become a part of the final laminate. This plate can optionally also be used as a pressing plate 20 as illustrated in FIG. 8. This is done by placing the bent plate over the insert during assembly of the laminate. Pressure applied during the lamination process to the pressing plate 20 will help the insert to conform to the shape of the bent glass and to force out any remaining air. This may be desirable if the insert is not bent to its final shape prior to assembly of the laminate as may be the case when the insert is comprised of a chemically tempered thin glass.

Alternately, the cutout can be made after bending but prior to lamination by means of a water jet, LASER, grinding or other suitable means.

The cutout area is provided with an insert which is bonded to the outer glass layer by an optical adhesive 28 as shown in many of the figures. The insert and adhesive can be made much thinner than the material replaced and can be manufactured with higher quality optical materials and to higher standards resulting in a corresponding higher optical quality than would otherwise be possible with a typical laminated windshield.

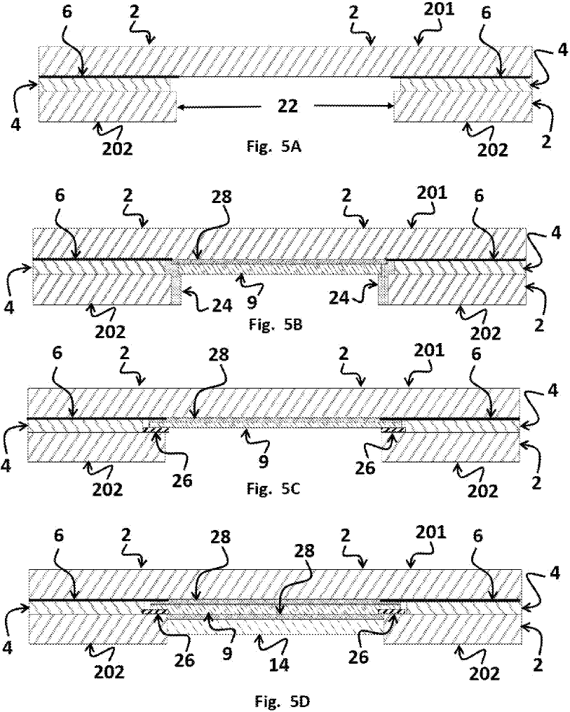

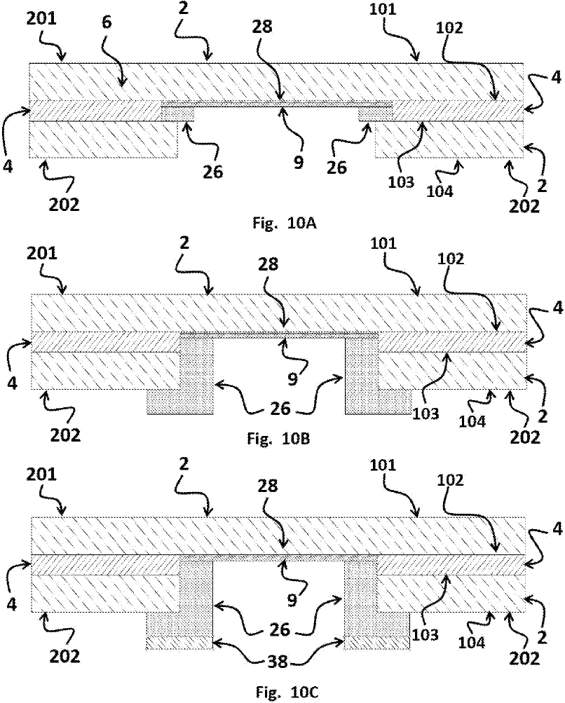

The interface between the insert and the inner glass edge is a weak point. When force is applied (impact, wind load, heavy rain, torsion, body flex, etc.), the edge of the inner glass layer surrounding the insert acts as a fulcrum creating stress. To prevent breakage and separation upon breakage, this interface can be reinforced with an adhesive, reinforcement, or some other type of filler to hold the insert in place and maintain a watertight seal if the glass is broken. Some examples are shown in FIGS. 5B, 6A, 10A, 10B and 10C. In FIG. 10C, in addition to the adhesive 28, a reinforcement 38 which overlaps the insert 9 and surface four 104 of the inner glass layer is shown.

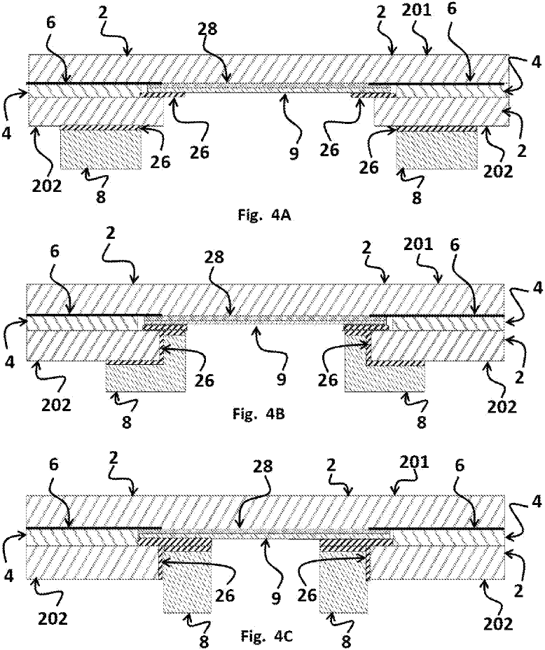

To further improve the strength of this weak point, the insert can be extended outboard of the edge of the cutout so as to overlap the edge of the cutout such that the insert is captured by and bonded to both the inner and outer glass layers to further improve the strength and penetration resistance of the laminate, preferably at least 2 mm. In this manner the edges of the insert are captured by both layer of glass within the laminate. The edges of the exposed interior surface of the insert can be bonded to surface three of the inner glass layer making for a much stronger laminate. Various embodiments are illustrated in FIGS. 4A, 4B, 4C, 5C, 5D, 6B, 6C, 6D, 9A, 9B, 9C and 10A (not to scale).

The insert may also be size to essentially the same or slightly small than the cutout as shown in 5B, 6A, 10B and 10C. This has the advantage in that the insert does not need to be applied during assembly of the laminate. This allows for the use of an optical adhesive that is not compatible with the heat and pressure of the lamination process.

In either case, the plastic interlayer must be at least partially cutback from the cutout. The insert 9 can be fabricated from any suitable material that can provide the optical quality and penetration resistance needed. Potential materials include but are not limited to chemically tempered glass, annealed glass, heat strengthened glass, cellulose triacetate (TAC), polyethylene terephthalate (PET), cast PET (CPET), transparent polyamide (PA), polyvinyl butyral (PVB), polyurethane (PU), polycarbonate (PC), acrylic, a transparent polymer plastic, a transparent elastomer, a transparent monomer plastic, a transparent lonomer plastic, a transparent ceramic.

CPET has also been proven effective. It too is extraordinarily strong and has the additional benefit of not requiring an adhesive to bond to the glass. CPET is a thermo-plastic that will bond to glass at standard autoclave and glass laminating process temperatures.

Non-oriented multi-layer polyester cast PET (CPET) film is produced by extrusion of amorphous polyethylene terephthalate. CPET has several properties that make it well suited for this application. The film has high surface tension which facilitates a strong bond to PVB, glass and other materials. The film can be formed and welded at glass lamination process temperatures. CPET film is widely available from many suppliers as it is used worldwide for printing, welding, laminating, gluing, and thermoforming.

The plastic bonding layer 4, typically PVB, can be used to bond the insert 9 to the surface of the outer glass layer 201. This is particularly advantageous in that the step can be accomplished by means of the standard automotive autoclave cycle. An autoclave is used to apply heat and pressure to an assembled laminate to complete the lamination process.

The insert may be further reinforced by additional components such as plates or other formed structures attached to the insert. The reinforcement may be formed as an integral part of the insert. An example would be an injected molded, cast, or machined reinforced insert.

When the insert is fabricated from thin chemically tempered glass, cold bending can be used to form the insert. In preferred embodiments, the insert comprises an aluminosilicate glass layer as a penetration resistance layer, preferably chemically tempered. In several alternative embodiments, the insert comprises a soda-lime or a borosilicate glass layer. The thickness of the glass layer may range from 0.5 to 2.5 mm, preferably from 0.5 to 1.6 mm, more preferably from 0.5 to 1.1 mm, even more preferably no more than 0.7 mm.

The use of an insert improves optics in part by reducing the thickness of the laminate in the camera area. Double image is reduced due to the shortening of the distance that the light travels and the resulting displacement of the secondary image.

In addition to double image being reduced by this disclosure the two main parameters that are improved are optical power (distortion in mdpt) and Modulation Transfer Function (MTF).

A lens may be designed to correct for optical aberrations and optically bonded to the surface of the insert. An optical adhesive is needed which is matched to the index of refraction of the glass. Such adhesives are known in the art and may be of the UV cure or solvent type.

To compensate for normal process variation, a plurality of lens may be provided with which to correct. In this case, each windshield is measured after lamination and the appropriate lens is selected.

An optical film may be used for the insert. An optical film is any film that has a primary function as serving as a part of an optical light path. Optical films are manufactured to have exceptional clarity and light transmission. They may have their spectral response tuned to attenuate certain wavelengths. One application of this selective attenuation is that of a color correction filter. When used in direct contact with another optical element, the film may have its index of refraction adjusted to match the mating component to minimize any discontinuities and resulting refraction and reflection. Optical films may also have exceptionally smooth surfaces.

An optical adhesive is needed to bond the insert to the outer glass. An optical adhesive is an adhesive that is designed for and typically used to bond optical components. The optical adhesive may be a liquid which is cured by heat, UV, catalytic or other appropriate means. The adhesive may also be comprised of a pressure sensitive adhesive such as but not limited to an acrylic. The optical adhesive may comprise a thermoplastic. A non-plasticized PVB film may be used as bonding means. This is especially advantageous when the non-plasticized PVB film is in contact with the plastic bonding layer used to join glass layers such that the plasticizer of the typical interlayer migrates by diffusion during the lamination. Likewise, said plastic bonding layer (typical plastic interlayer) may be used as optical adhesive.

The primary disadvantage of the plastic interlayer lies in its greater thickness as compared to other optical adhesive which require thickness far less than that of an interlayer. The thickness of an optical adhesive will typically be at least an order of magnitude less than that of the typical interlayer. The variations in thickness, the temperature dependent index or refraction and embossed surfaces of the typical plastic interlayer have optical properties that are inferior to dedicated optical adhesives. Still, by replacing the glass in the area with and optically superior and thinner insert, and improvement can be made. With everything else the same, thinner is always better. With an insert and optical adhesive having a combined thickness of less than or equal to 1.0 mm, significant optical improvement is made. Prototypes have been made with a thickness of 0.25 mm. It may be possible to reduce the total thickness to as little as 50 microns depending upon the size and location of the cutout, material selected, laminate bent shape and other factors.

The most common interlayer, PVB, has an index of refraction that is very close to that of soda-lime glass and PVB has exceptional clarity once laminated. However, PVB typically has an embossed finish to facilitate handling and de-airing. While the embossing largely disappears during lamination, it may still contribute to some level of optical aberration. Liquid optical adhesives have been developed specifically for this type of application. Applied in liquid form, they will conform to the contours and any irregularities, even microscopic, in the glass surfaces may be filled. Optical pressure sensitive adhesives area also available for this same application.

A mounting bracket will generally be required to mount the cameras. In some cases, the mounting bracket is not attached to the windshield. When the bracket is mounted to the glass, the bracket can serve the auxiliary function of reinforcing the cutout in the camera area.

The bracket can be mounted directly to the inner glass surface, to the insert or to both. Any suitable adhesive can be used. Some of the adhesive that are in common use for this type of application include two component polyurethane as well as single component moisture curing polyurethanes.

The edge of the bracket may be extended such that it overlaps the edge of the cutout on the inner glass edge. The overlap area may also be bonded to the glass to improve the strength of the laminate.

The insert and the bracket may be further reinforced to provide for additional strength. Common means include but are not limited to increasing the thickness in at least a portion of the area of the bracket, insert or both, adding additional structural member to the assembly, the use of a stiff interlayer in place of at least a portion of the cutout area.

The gap between the cutout and the camera mounting means can be filled with an adhesive to improve the strength of the laminate. There are several appropriate adhesives that are known in the art which include but are not limited to: the two-component polyurethane and single component moisture cure polyurethane are good candidates as well as hot-melt and epoxy. As this is not in the camera field of view, the adhesive does not need to be clear.

It should also be noted, as one of ordinary skill in the art can appreciate that the disclosure can be applied to other laminates and positions in addition to the windshield. The windshield is just the most common location to date and the only position which is required by law to be comprised of laminated safety glass.

### DETAILED DESCRIPTION OF THE EMBODIMENTS

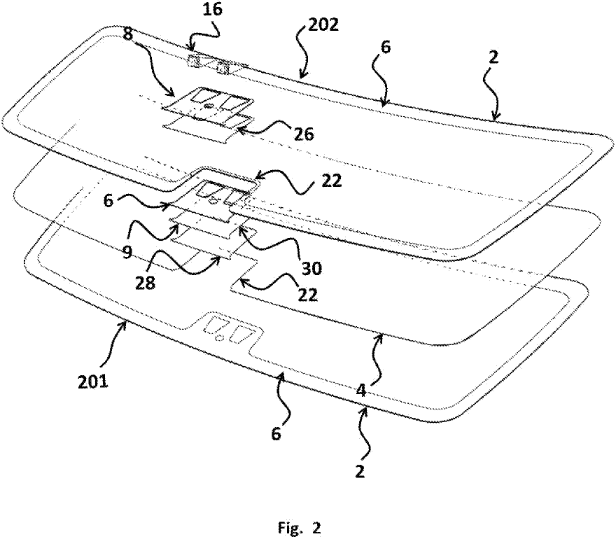

Embodiment one is illustrated in FIG. 2. The windshield has a 2.1 mm thick outer glass layer 201 comprised of clear, annealed, soda-lime glass. The inner glass layer 202 is comprised of 1.6 mm solar green, annealed, soda-lime glass. In the camera 16 field of view, a cutout 22 is made in both the plastic bonding layer 4 and in the inner layer of glass 202. The cutout 22 in the inner glass layer is made in the flat glass, prior to bending, as the shape is cut from the rectangular block size glass. The two glass layers are heated and bent by means of a gravity bending process. A separate piece of glass (not shown), cut to the shape of the cutout, is also fabricated, and then placed in the cutout 22 to facilitate uniform heating during the bending process. An insert 9, 6 mm larger than the cutout 22, is made from a 200-µm thick polymeric optical film. The insert 9 has a transparent conductive coating 30 applied to the optical adhesive facing side of the insert and an obscuration 6 is printed on the other side. The transparent conductive coating is connected to the vehicle electrical system via a set of oppositely disposed thin copper bus bars bonded to the transparent conductive film. When a voltage is applied, the coating 30 heats the insert keeping it clear of fog and ice. The insert 9 is bonded to the outer glass layer 201 using an optical adhesive 28 which is cured in the autoclave using a standard automotive cycle. The two glass layers are laminated by means of a single PVB interlayer 4 with a thickness of 0.76 mm. The interlayer 4 is cutback to accommodate the insert 9. The bent glass plate, used to facilitate bending, is placed over the insert 9 during assembly of the laminate where it functions as a pressing plate. The camera mounting bracket 8 is bonded to the number four surface 104 of the inner glass 202 and the insert 9 by means of a two-component polyurethane adhesive 26 after lamination. The cameras 16 are mounted at the vehicle assembly factory after installation of the windshield into the vehicle.

The panoramic windshield of FIGS. 3 and 8 has a clear soda-lime, 2.1 mm thick outer glass layer 201. The inner glass layer 202 is comprised of 1.6 mm thick solar green soda-lime glass. An infra-red reflecting triple silver MSVD coating 18 is applied to surface two 102 of the outer glass 201 layer. After singlet press bending of the two glass layers a cutout 22 is made in the inner layer of glass 202 using a femto-second LASER. In the camera field of view, a cutout 22 is made in the plastic bonding layer4 using a CNC blade cutter. An insert 9, 6 mm larger than the cutout is made from 0.25 mm chemically strengthened aluminosilicate glass. The insert 9 is bonded to the outer glass layer 201 by means of a liquid optical adhesive 28. The insert 9 is bonded to the inner glass layer 202, along the portion where the two overlap, by means of a 50 µm thick thermo-plastic adhesive. The two glass layers, after bending, are laminated by means of a PVB layer with a thickness of 0.76 mm. The 0.76 mm interlayer 4 is cutback to accommodate the insert 9. The glass plate, used to facilitate bending, is placed over the insert during assembly of the laminate where is functions as a pressing plate.

A camera mounting bracket is bonded to the number four surface of the inner glass 202 by means of a two-component polyurethane adhesive after lamination. The cameras are mounted at the vehicle assembly factory after installation of the windshield into the vehicle.

Embodiment 3 is the same as embodiment two with the exception of the insert being cold bent during the lamination process.

Embodiments 4 is the same as embodiment one with the exception of the insert being cut to 3 mm smaller than the cutout.

Embodiment 5 is the same as embodiment two with the exception of the insert being cut to 3 mm smaller than the cutout.

Embodiment 6 is the same as embodiment one with the exception of the mounting bracket being mounted to only the inner glass layer.

Embodiment 7 is the same as embodiment two with the exception of the mounting bracket being mounted to only the inner glass layer.

Embodiment 8 is the same as embodiment two with the exception of the insert being fabricated from 50 µm CPET.

Embodiment 9 is the same as embodiment two with the exception of the insert being fabricated from 100 µm TAC.

Embodiment 10 is the same as embodiment two with the exception of the insert being fabricated from 125 µm PET.

Embodiment 11 is the same as embodiment two with the exception of the insert being fabricated from 100 µm PA.

Embodiment 12 is the same as embodiment two with the exception of the insert being fabricated from 100 µm PU.

Embodiment 13 is the same as embodiment two with the exception of the insert being fabricated from 100 µm acrylic.

Embodiment 14 is the same as embodiment two with the exception of the insert being fabricated from molded PU wherein a lens is formed.

Embodiment 15 is the same as embodiment two with the exception of further comprising a molded PU lens optically bonded to the insert.

Embodiment 16 is the same as embodiment 14 with the exception of the optical properties of the lens being matched to measured optical characteristics of the individual laminate.

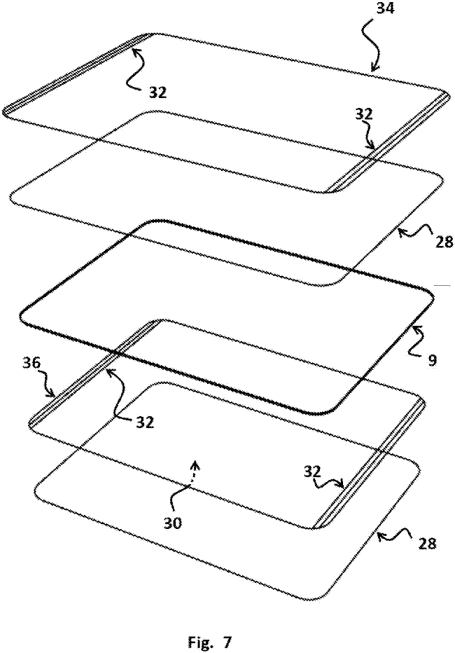

Embodiment 17 is embodiment 1 further enhanced by the addition of a switchable layer 34 (FIG. 7).

Embodiment 18 is embodiment 1 further enhanced by the addition of an insert heating means 36 (FIG. 7) comprising a transparent conductive coating 30 having a power density of 10 watts per dm2.

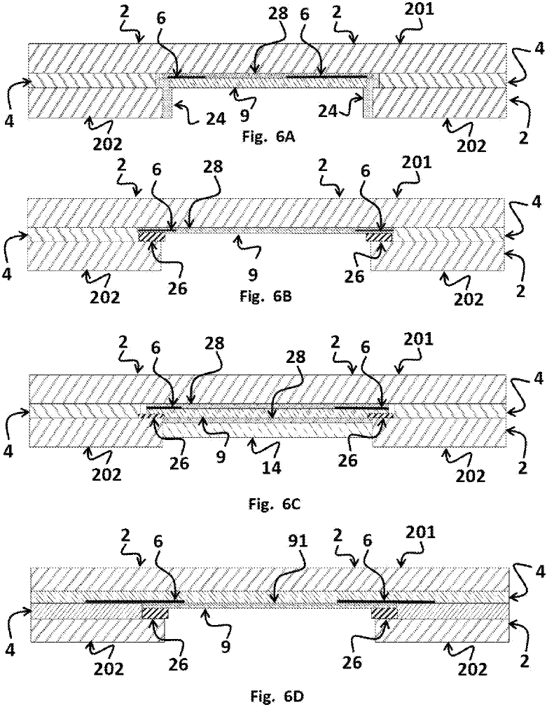

Embodiment 19 is embodiment 1 modified as follows. An obscuration 6 is provided by means of printing black on a 50 µm thick PVB substrate. The insert 9 utilizes a pressure sensitive acrylic adhesive 91 which bonds the insert 9 to the thin printed PVB 4. The insert 9 is bonded to the inner glass layer 202 with an adhesive 26. Two layers of PVB 4 are used in addition to the obscuration PVB layer. This cross-section is illustrated in FIG. 6D.

Embodiment 20 identical to embodiment one with the following exceptions. Two 0.76 thick layers of PVB 4 are used. The insert 9 is positioned between the two PVB 4 layers. The PVB 4 layer in contact with surface three 103 is cutout to with an opening that is 6 mm smaller than the insert. The area of overlap serves to bond the insert to surface three 103 of the inner glass layer 202. In this manner the PVB layer serves as and takes the place of a separate optical adhesive, bonding surface two of the glass to the insert and also serves as and takes the place of an adhesive bonding surface three to the insert. A black obscuration 6 is applied to surface two 102 of the outer glass layer 201.

Embodiment 21 is identical to embodiment 20 with the following exception. The black obscuration is applied to the insert itself. In this embodiment it is applied by means of inkjet printing an organic black ink. It may also be implemented by any of the numerous other methods and materials known in the art. The obscuration may also be implemented as a thin opaque layer applied to the insert such as a non-plasticized PVB to mention but one possible material.

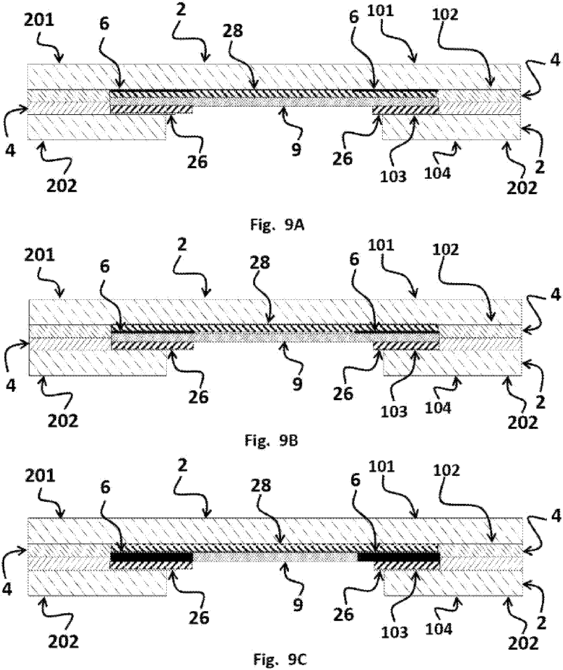

Embodiment 22 is identical to embodiment 21 with the following exception. The black obscuration is formed as an integral part of the insert. In this embodiment, the clear portion of the insert is formed from an acrylic plastic. The clear portion is then bonded to a black opaque acrylic. The insert of this embodiment is similar to the one depicted in FIG. 9C.

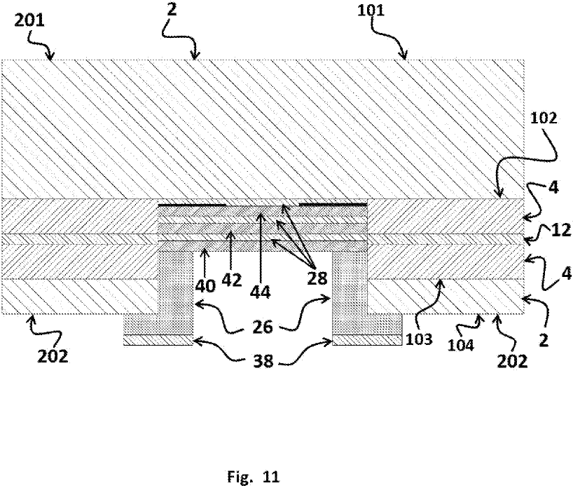

Embodiment 23 is identical to embodiment 2 with the following exceptions. The outer glass layer 201 is 3.8 mm thick. The inner glass layer is 0.7 thick chemically tempered aluminosilicate glass. A layer of IR reflecting film 12 is placed between two 0.76 mm thick layers of PVB 4. The insert is multi-layer. The surface exposed to the interior of the vehicle is an anti-reflective coated thin plastic film 40. This film is optically bonded to a second plastic film which has bus bars and a conductive coating for defrosting 42. The conductive coated layer 42 is optically bonded to a plastic film 44 that has a black obscuration printed on it. The three layers are bonded together into an assembly prior to lamination. After lamination, the assembly is optically bonded to the outer glass layer 201. An adhesive 26 is used to fill the cutout along the edges bonding the insert to the inner glass layer 202. Optionally, a 10 mm wide reinforcement 38 may be bonded to the laminate as well. This cross-section is illustrated in FIG. 11.

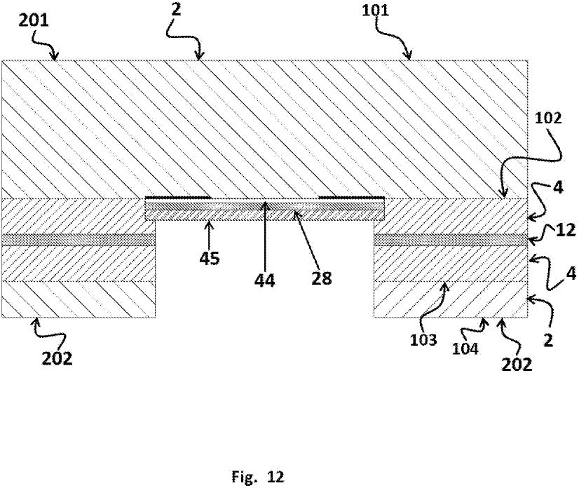

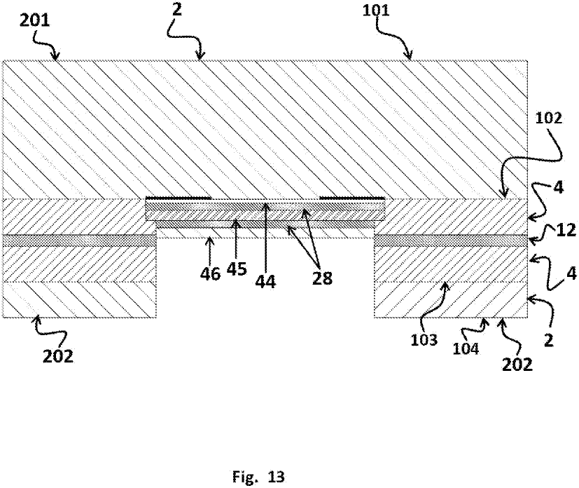

Embodiment 24 is identical to embodiment 2 with the following exceptions. The outer glass layer 201 is 3.8 mm thick. The inner glass layer is 0.7 thick chemically tempered aluminosilicate glass. A layer of IR reflecting film 12 is placed between two 0.76 mm thick layers of PVB 4. The insert is a functional layer 45 having at least one of the following elements: penetration resistance layer, transparent conductive coating, heating layer, anti-glare coating, anti-reflective coating, anti-fog coating, switchable layer, or a combination thereof. The functional layer 45 is bonded to the outer glass layer by an optical adhesive 28, 44 comprised of a printed film 44 such as a non-plasticized PVB film having a black obscuration printed on it, and an optical liquid adhesive 28. The layers are bonded together into an assembly prior to lamination. This cross-section is illustrated in FIG. 12.

Embodiment 25 is identical to embodiment 2 with the following exceptions. The outer glass layer 201 is 3.8 mm thick. The inner glass layer is 0.7 thick chemically tempered aluminosilicate glass. A layer of IR reflecting film 12 is placed between two 0.76 mm thick layers of PVB 4. The insert is a multi-layer insert. The surface of the insert exposed to the interior of the vehicle is a 0.25 mm chemically strengthened aluminosilicate glass layer 46 bonded to a functional layer 45 such as a heating means implemented as a plastic film 6 mm larger than the cutout. The plastic film has bus bars and a conductive coating for defrosting. The conductive coated film 45 is optically bonded to the outer glass layer 201 by means of an optical adhesive comprised of a pressure sensitive adhesive 28 and a black obscuration printed on a thin film 44. The layers are bonded together into an assembly prior to lamination. Alternatively, the optical adhesive may comprise an optical liquid adhesive instead of the pressure sensitive adhesive 28.

As can be appreciated, further embodiments may be created by means of a full factorial of the many features described and claimed for the disclosure. All possible combinations are not enumerated but anyone may be derived from the specification set forth within.

What is claimed is:

1. A laminated glazing having a cutout area in a camera field of view, comprising:
an outer glass layer;
an inner glass layer having a cutout in the cutout area;
a first plastic bonding layer positioned between opposite faces of the inner and the outer glass layers, said first plastic bonding layer has a cutout in the cutout area; and
an insert bonded to the outer glass layer by means of an optical adhesive and sized to substantially cover the exposed outer glass layer in the cutout area;
wherein the first plastic bonding layer is arranged adjacent to the outer glass layer.

2. The laminated glazing of claim 1, wherein the insert is bonded to the inner glass layer.

3. The laminated glazing of claim 1, wherein the optical adhesive is an optical liquid adhesive or a pressure sensitive adhesive.

4. The laminated glazing of claim 3, wherein the optical liquid adhesive is cured by heat, UV or catalytic means.

5. The laminated glazing of claim 1, wherein the thickness of the optical adhesive is less than that of the first plastic bonding layer.

6. The laminated glazing of claim 1, wherein said insert at least partially overlaps the inner glass layer.

7. The laminated glazing of claim 1, wherein a camera mounting bracket is bonded to the insert, the inner glass layer or both.

8. The laminated glazing of claim 1, wherein the insert is of a thickness that is between 0.05 mm and 1.0 mm.

9. The laminated glazing of claim 1, wherein the insert is comprised of at least one of the following penetration resistance materials: chemically tempered glass, annealed glass, heat strengthened glass, cellulose triacetate (TAC), polyethylene terephthalate (PET), cast PET (CPET), transparent polyamide (PA), polyvinyl butyral (PVB), polyurethane (PU), polycarbonate (PC), acrylic, an optical film, a transparent polymer plastic, a transparent elastomer, a transparent monomer plastic, a transparent ionomer plastic, a transparent ceramic, a transparent glass-ceramic.

10. The laminated glazing of claim 9, wherein the insert is a composite bilaminate comprised of at least two of the materials.

11. The laminated glazing of claim 1, wherein the insert is comprised of one or more of the following elements: a penetration resistance layer, an obscuration, a heating means, an antireflecting coating, an antifog coating, an antiglare coating, and a switchable layer.

12. The laminated glazing of claim 1 further comprising at least one lens assembly.

13. The laminated glazing of claim 1, wherein the insert is cold bent.

14. The laminated glazing of claim 1 further comprising an obscuration for the camera window, said obscuration is printed on at least one of the following: the insert, a plastic bonding layer, or a film.

15. The laminated glazing of claim 1 further comprising an infra-red reflecting film and a second plastic bonding layer, both layers having a cutout in the cutout area and being positioned between opposite faces of the first plastic bonding layer and the inner glass layers; wherein the second plastic bonding layer is arranged adjacent to the inner glass layer.

16. The laminated glazing of claim 1, wherein the insert is a multi-layer insert comprised of layers joined each other by optical adhesive means.

17. The laminated glazing of claim 16, wherein at least two layers of the multi-layer insert have different sizes.

18. The laminated glazing of claim 1, wherein the insert comprises an obscuration layer selected from the group consisting of: a printed film, a film made of an opaque material, a printed penetration resistance layer, and an opaque material implemented as an integral part of the penetration resistance layer.

19. The laminated glazing of claim 1, wherein the optical adhesive is a thermoplastic layer having a thickness less than that of the first plastic bonding layer.

20. The laminated glazing of claim 1, wherein the optical adhesive comprises an obscuration for the camera window.

21. The laminated glazing of claim 20, wherein the obscuration is a printed non-plasticized PVB film.

22. The laminated glazing of claim 16, wherein the multi-layer insert comprises a penetration resistance layer and a heating means bonded to the outer glass layer by means of an optical adhesive.

23. The laminated glazing of claim 1 or 22, wherein the optical adhesive comprises a printed non-plasticized PVB and an optical liquid adhesive.
